(19) United States
(12) Patent Application Publication
(10) Pub. No.: US 2009/0002686 A1
(43) Pub. Date: Jan. 1, 2009

(54) Sheet Metal Oxide Detector

(75) Inventors: Kevin C. Voges, Shiloh, IL (US); Stuart H. Critchley, Dundas (CA); Victor Wasyl Chupil, Stoney Creek (CA)

Correspondence Address: THOMPSON COBURN, LLP, ONE US BANK PLAZA, SUITE 3500, ST LOUIS, MO, 63101, US

(73) Assignee: THE MATERIAL WORKS, LTD., Red Bud, IL (US)

(21) Appl. No.: 11/771,347

(22) Filed: Jun. 29, 2007

(51) Int. Cl. G01N 21/00; G01J 4/00; G01N 21/84

(52) U.S. Cl. 356/73; 356/369; 356/430; 356/431

(57) ABSTRACT

An apparatus for detecting residual oxide or scale present on a metal surface following pickling or mechanical processing of the metal surface to remove scale makes use of laser light that is reflected off of the metal surface, a reflection detector that detects the absolute reflectivity and polarization of the reflecting laser light, a roughness measurement sensor, and a computerized control system that uses combinations of the information from the three sensors to provide an indication of the scale remaining on the metal surface.

### BACKGROUND OF THE INVENTION

1. Field of the Invention

The present invention pertains to an apparatus and method for detecting and quantifying residual oxide or scale present on the surface of processed sheet metal. This is important following or during pickling or mechanical processing of the sheet metal to remove scale. Additional applications evident to those skilled in the art include processes that may influence an existing scale layer on a metal surface, either as part of a process that is designed to produce a controlled surface scale condition, such as the so-called bluing of stovepipe, or in-processes where the production of an oxide surface layer would indicate a problem in the metal surface, such as an annealing process. The apparatus and method of the invention basically make use of combinations of three sensors. The first two sensor configurations use laser light that is reflected off the surface of the process sheet metal. In one system, a reflection detector detects the absolute reflectivity of the laser light from the surface, and in the second system a reflection detector detects changes to the polarization of the laser light. The third system, which may or may not use laser light, detects the surface texture or roughness of the surface. All three sensors provide input to a computerized system that uses this information from the reflection detectors and the roughness detector to provide an indication of the scale remaining on the surface of the processed sheet metal.

2. Description of the Related Art

In many cases, an early step in the processing of hot rolled sheet metal, or castrip, destined to be used to produce manufactured goods such as household appliances, automobile parts, aircraft parts, etc. is to remove the scale or oxides from the surfaces of the metal. This descaling is often referred to as pickling. Carbon steels are normally descaled using acid pickling. Stainless steels may use a combination of mechanical and acid descaling techniques.

The ability to detect residual oxide present on the processed sheet metal surfaces during or following a pickling or mechanical processing of the sheet metal is critical to ensure the sheet metal is oxide free. Measuring the residual oxide present during or immediately after processing provides the operator with the ability to apply control systems to optimize the process. Typically, the process is monitored by direct visual observation of the strip by the line operators at the exit of the process. Quantitative information is not normally available. The pickling operator visually inspects the strip exiting the pickling process to ensure that the strip has a bright appearance and is consistent in color. The operator inspecting the strip is restricted to making a subjective judgment based on the brightness and color of the strip. The operator's judgment determines that the strip is substantially “free” from scale, even though the strip may still have some residual oxide present. This prior method of detecting residual scale is problematic in that the method either results in lost productivity when the material processing is running too slowly to obtain the maximum line speed, resulting in overpickling of the material when the processing time becomes excessive, or the material processing running too fast, resulting in some scale still remaining on the surfaces of the strip. Thus, the problems associated with the prior art visual inspection method for residual scale are problems in the quality of the metal strip produced, and problems in the efficiency of producing the metal strip.

Additionally, to determine quantitatively the level of oxide left present on the surfaces of the processed sheet metal, processing companies rely on measurements of discreet samples of the sheet metal taken at predetermined periods during the processing of the sheet metal. These samples are analyzed in a laboratory that is separate from the processing line of the sheet metal. This approach is time consuming and does not allow for the direct, immediate, on-line feedback control of the sheet metal processing. In addition, the samples taken are discreet and are not necessarily representative of the whole coil of sheet metal being processed where the extent of residual scale could vary from edge to edge or from the beginning to the end of the coil. Thus, the existing manner of testing for residual scale on the surfaces of processed sheet metal is inefficient and unreliable.

### SUMMARY OF THE INVENTION

The apparatus of the invention and its method of use overcome the disadvantages associated with the prior art testing of processed sheet metal to determine levels of residual oxide scale on the sheet metal surfaces. One embodiment of the apparatus of the invention is designed to be made a part of a sheet metal processing line. This eliminates the prior art process of periodically removing samples of sheet metal from the processing line and taking those samples to a separate laboratory for residual oxide scale testing. (However, some laboratory testing may be required in the initial calibration of the apparatus. Laboratory testing is eliminated as a production tool, and in the present invention laboratory testing is only of value as an independent option for calibration and standardization checks of the apparatus and method of the invention). Thus, the invention provides a time efficient way of real time testing of oxide levels on the surfaces of sheet metal as the sheet metal is being processed. The invention also therefore enables real time adjustments to the processing of the sheet metal to control or manage the level of residual scale on the surfaces of the sheet metal.

The optical properties of metal oxides and of the metal itself are unique and measuring these properties allows the determination of the surface components. If measuring these optical properties could be done on a perfectly flat sample of the metal either reflectivity or depolarization could be used to indicate the relative amounts of oxide and metal in the surface layer.

Since surface roughness can influence these measurements of the optical properties, compensation for surface roughness changes will improve the accuracy of the measurement system. This can be done by calibrating the optical sensors either individually or in combination to a particular sheet metal process operating in a restricted range of operating conditions, or preferably by coincident measurement of the surface texture or roughness of the metal surface being tested. The surface roughness sensor of the apparatus of the invention can be a contact or non-contact sensor. Sensors of this type are available in the prior art. Using this method produces a sensor that is independent of the metal processing or the process set points.

The apparatus includes one or more laser light sources positioned along a sheet metal processing or descaling line where a sheet metal strip that has been processed or is being processed will move past the laser light source. The laser light source is positioned to project a beam of laser light onto the surface of the sheet metal strip moving in front of the laser light source. The light could be projected as a point on the surface or as a line on the surface. The beam of laser light projected to the moving surface of the metal strip is reflected from the surface of the metal strip.

A reflection detector is positioned along the sheet metal processing line to detect the laser light reflecting from the moving surface of the metal strip. The reflection detector can be positioned at an opposite side of the width of the metal strip from the laser light source, or could be positioned relative to the laser light source where both the reflection detector and the laser light source are in line with the length of the metal strip. Basically, the laser light source or sources and the associated reflection detector or detectors can be installed relative to the sheet metal processing line at any angle to the metal strip direction of travel.

In addition to testing the reflectivity of the metal strip, the apparatus of the invention includes light polarizing filters that can be positioned in line with the incident laser light and the reflected laser light allowing a determination of a change in the polarization of the reflected light, or an additional laser-light source with a polarizing filter and an additional reflection detector with a polarizing filter that monitor the change in polarization of the laser light reflected from the sheet metal strip surface. In either embodiment, the laser light source includes a first polarizing filter that is positioned to receive the beam of laser light projected from the laser light source. The first polarizing filter polarizes the beam of laser light so that a polarized beam of laser light is projected to the moving surface of the metal strip and reflects from the moving surface.

A second polarizing filter is associated with the reflection detector. The second polarizing filter is positioned relative to the reflection detector to receive the laser light from the laser light source that is reflected from the moving surface of the metal strip. The second polarizing filter is positioned so that the reflection detector detects laser light reflecting from the moving surface of the metal strip that has been transmitted through the second polarizing filter.

A computerized monitoring and control system communicates with the reflection detector or detectors, and the roughness sensor system. The computerized control system is operable to receive signals from any or all of the reflection detectors and the roughness detector and produce signals that are indicative of the level of oxide scale remaining on the surface of the metal strip based either singly or in combination of the absolute reflectivity of the reflected light, the change in polarization of the reflected laser light detected by the reflection detector, and the roughness sensor system.

In one embodiment of the apparatus, the laser light source and the reflection detector are paired together as a single sensor unit. A plurality of sensor units that each comprise a laser light source and a reflection detector are arranged side-by-side across the width of the metal strip. The plurality of sensor units effectively monitor the residual oxide scale on the surface of the metal strip moving past the apparatus.

In an alternate embodiment of the invention, movable scanning optics are positioned relative to the laser light source to receive the beam of laser light from the laser light source and direct the beam of laser light across the width of the metal strip. The scanning optics direct the beam of laser light in a back and forth pattern across the width of the metal strip, thereby effectively monitoring the residual oxide scale across the surface of the metal strip moving past the apparatus.

In a still further embodiment of the invention, line generating optics are positioned relative to the laser light source to receive the beam of laser light from the laser light source and direct a line of laser light across the width of the metal strip. Alternatively, two or more lines of laser light could be projected on the surface of the metal strip to completely cover the width of the strip. The line or lines of laser light projected across the width of the metal strip effectively monitor the residual scale on the surface of the metal strip moving past the apparatus.

Each of the embodiments of the apparatus discussed above is incorporated into the sheet metal processing line and provides real time detection of residual oxide scale on the surface of the sheet metal moving through the processing line. This provides a cost efficient and time efficient apparatus and method of detecting residual oxide scale on the surfaces of the sheet metal, and enables real time adjustments to the processing line to achieve a desired level of residual scale.

### DESCRIPTION OF THE DRAWING FIGURES

Further features are set forth in the following detailed descriptions of the preferred embodiments of the invention and in the drawing figures.

FIG. 1 is a schematic representation of a sheet metal processing line that descales the surfaces of metal and comprises the apparatus of the invention and its method of use.

FIG. 2 is a schematic representation of a first embodiment of the apparatus of the invention that detects scale on the surfaces of a metal strip being processed on a metal processing line such as that shown in FIG. 1.

FIG. 3 is a schematic representation of a further embodiment of the scale detecting apparatus of the invention.

FIG. 4 is a schematic representation of a further embodiment of the scale detecting apparatus of the invention.

FIG. 5 is a schematic representation of a still further embodiment of the scale detecting apparatus of the invention.

### DETAILED DESCRIPTION OF THE PREFERRED EMBODIMENTS OF THE INVENTION

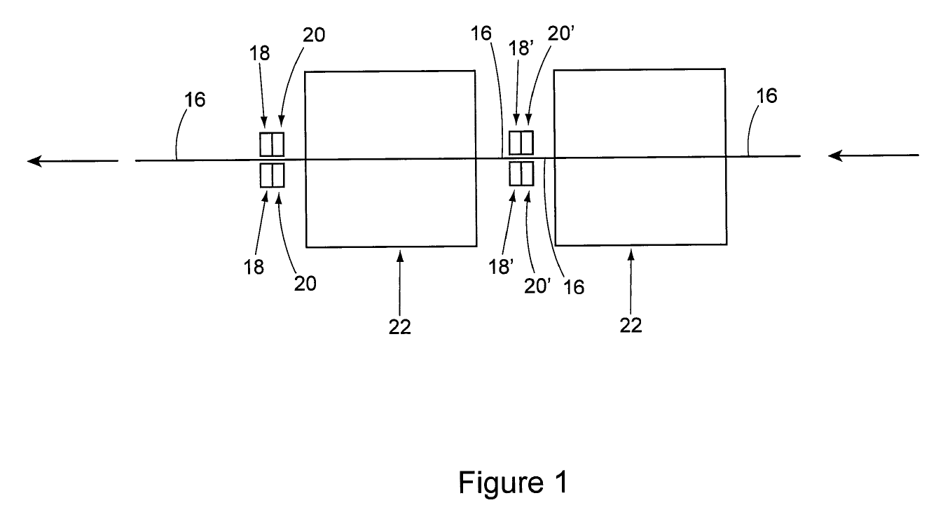

FIG. 1 shows a schematic representation of a metal processing line in which the apparatus of the invention is used. The processing line of FIG. 1 receives a length of sheet metal and removes scale from the opposite surfaces of the length of sheet metal as the length of sheet metal passes through the processing line. The apparatus of the invention, as will be explained, may be employed in a processing line such as that of FIG. 1 to detect any residual scale remaining on the surfaces of the descaled sheet metal. The processing line shown in FIG. 1 is only one example of an environment in which the apparatus of the invention may be used. Therefore, the processing line of FIG. 1 should not be interpreted as the only environment in which the apparatus may be used. FIG. 1 basically represents a strip of metal 16 that is moving relative to the oxide detector apparatus 18 of the invention, which includes a surface roughness detector or sensor 20, whereby the apparatus 18 detects any residual oxide scale on the surfaces of the strip 16. The surface roughness sensor 20 can be included as an integral part of the apparatus 18, or could be a separate sensor employed with the apparatus 18. The roughness sensor 20 could be a contact sensor or a non-contact sensor. Roughness sensors 20 of this type are known in the art, and therefore the roughness sensor 20 is shown schematically only in FIG. 1. This sensor 20 communicates with the monitoring and control system of the invention to be described. In the illustrative embodiment of FIG. 1, the strip 16 is moved through a strip processing section 22 that removes scale from the opposite surfaces of the strip. The section 22 could be a conventional pickling system, or it could be a mechanical system for removing scale. It is intended that any type of system that is capable of removing oxide scale from the surfaces of metal strip 16 be represented by the system 22 schematically shown in FIG. 1.

Furthermore, it is not necessary that the metal strip 16 be moved relative to the apparatus 18 for detection of residual scale on the surfaces of the strip. In an alternate and equivalent embodiment, the strip 16 could be substantially stationary and the apparatus 18 could be moved over the surfaces of the metal strip. In an alternate and equivalent embodiment, the strip 16 could be substantially stationary and the apparatus 18 could be moved over the surfaces of the metal strip. For example, in processing the surfaces of a ship's metal hull to remove scale, or in the practice of some other process that is not intended to produce scale on a metal surface but may produce scale if the process is not performed correctly, the apparatus of the invention 18 can be used to detect any scale or oxide levels on the metal surfaces. As a further example, the apparatus 18 could be adapted to detect residual scale or oxide levels on the metal surfaces of a bridge after the bridge surfaces have gone through a descaling process and prior to the painting of the metal surfaces.

In all potential applications of the invention, it should be understood that the concept of the invention is the detection and measurement of levels of scale remaining on metal surfaces by combinations of reflectivity measurements, polarization measurements of laser light reflected from the surfaces, and surface roughness measurements.

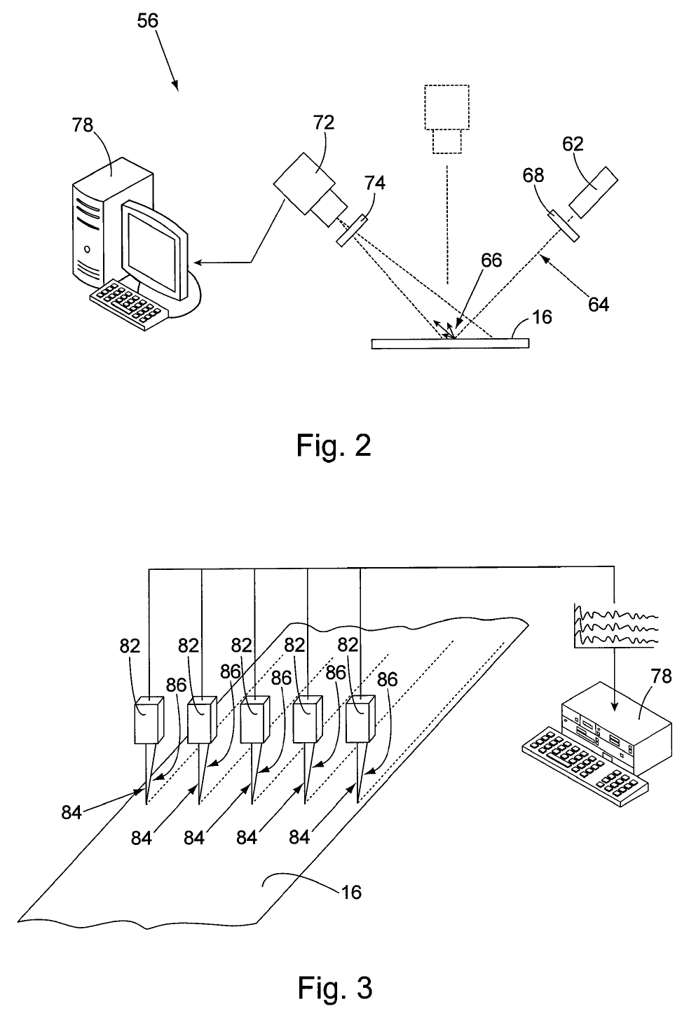

Referring to FIG. 2, a schematic representation of a first embodiment of the apparatus of the invention 26 is shown positioned adjacent the surfaces of a metal strip 16, with the apparatus 26 and the metal strip 16 moving relative to each other. The width dimension of the metal strip 16 extends from side to side in FIG. 2. Thus, FIG. 2 shows a cross-section of the width dimension of the metal strip 16 that is moving relative to the apparatus 26 out of the plane of FIG. 2. In the embodiment shown in FIG. 2, the laser light source 32 is a diode laser. The laser light source 32 is positioned to project a beam of laser light 34 toward the surface of the sheet metal strip 16 where the beam of laser light 34 reflects 36 from the sheet metal surface.

Optical scattering of the laser light beam 34 occurs as the laser light beam reflects 36 from the surface of the sheet metal strip 16. The degree of optical scattering of the reflected beam 36 is related to the surface chemistry and the surface roughness variation of the metal strip 16. As the metal strip 16 is processed and oxide scale is removed, the surface roughness of the strip 16 becomes altered in nature. For example, as the original oxide layer grows on the surface of the metal strip 16 it may be smoother than the underlying, steel substrate. As the oxide layer is removed or descaled and the steel surface becomes exposed on the metal strip 16, the roughness of the strip surface may increase or decrease, depending on the nature of the process and the stage of the processing. Thus, the laser beam reflection 36 from the strip surface and the measurement of the scatter of the reflection 36 can be influenced by a combination of the surface roughness variation, and the level of residual scale on the surface of the metal strip.

The apparatus of the invention shown in FIG. 2 is designed to determine combinations of the absolute reflectivity of laser light from the surface of the metal strip, and also to determine changes in the polarization of the laser light reflected from the surface of the strip 16, and the surface roughness of the strip 16. The measured reflectivity and the changes in the polarization of reflected light and the surface roughness can be used to determine a level of residual scale on the surface of the metal strip 16. In determining absolute reflectivity, it is only necessary that light be reflected from the surface of the strip 16. In determining changes in the polarization of light, the light reflected from the surface of the strip 16 must first be polarized in a predetermined polarization orientation in order to detect any changes in the polarization of the light reflected from the surface of the strip 16.

In addition to the laser light beam being scattered as it is reflected 36 from the surface of the strip 16, the beam is also polarized. This can be accomplished by providing a polarizing filter, for example a linear polarization filter 38 with the laser light source 32. The polarization filter 38 can be displaced away from the beam of light projected from the laser light source 32 when only absolute reflectivity of the light is being determined. When it is desired to determine the change in polarization of light reflected from the surface of the strip 16, the polarization filter 38 is positioned in line with the laser light directed toward the surface of the strip 16 from the laser light source 32. In an alternate embodiment, two laser light sources could be provided. One laser light source would direct light toward the surface of the metal strip 16 to determine absolute reflectivity of the light, and the second laser light source would direct a laser beam through the polarization filter 38 to the surface of the metal strip 16 to determine the change in polarization of the reflected light. In a further alternate embodiment, a single laser light source could be provided with the beam of the single laser light source being split into two beams that are directed toward the surface of the metal strip 16. One of the split beams is polarized and the other is not. Two cameras are employed to determine the absolute reflectivity of the reflected, split laser light beam that is not polarized and to determine the change in polarization of the reflected, split laser light beam that is polarized. In the examples of the different embodiments of the invention to follow, the laser light source of each embodiment is described as being associated with a polarization filter. However, this should be understood that each embodiment is capable of directing light to the surface of the metal strip without the light passing through a polarization filter to determine the absolute reflectivity of the light, and is capable of directing light through a polarization filter to the surface of the metal strip to determine the change in polarization of the reflected light. In each description, it is intended that the laser light source of the description be interpreted to include a laser light source that alternately projects a laser beam to the surface of the metal strip that is polarized and is not polarized, to include at least a pair of laser light sources that project a pair of laser beams to the surface of the metal strip with one beam of the pair being polarized and one beam of the pair not being polarized, and to include a single laser light source that projects a beam toward the surface of the metal strip where the beam is split into two split beams, with one split beam being polarized and one split beam being not polarized.

The polarization state of a given laser light beam is the direction in which the electromagnetic field vector points as the beam wave moves through space. Light that is emitted from a typical incandescent bulb is random and not polarized. However, light in a laser beam is not random and is “linearly” polarized. In linearly polarized light the orientation of the electromagnetic field vector remains constant and oriented in one linear direction as the laser light beam wave moves through space.

When a linearly polarized beam of light is reflected from the surface of the metal strip 16, the light reflects from facets of the surface. This reflection or scatter 36 of the beam tends to rotate the polarization of the scattered beam. The change of polarization upon reflection is due to the chemistry of the surface and to the scatter from the surface roughness. Therefore, measuring the extent to which the initial polarization of the laser light beam 34 is changed in the reflected or scattered laser light 36 can be used to provide an indication of the surface roughness of the strip 16.

To sense the change in polarization of the laser light beam reflected from the surface 36, a first polarizing filter 38 is positioned relative to the laser light source 32, where the beam of laser light 34 passes through the polarizing filter 38 and is linearly polarized in a predetermined orientation. The first polarizing filter 38 can polarize the laser light beam 34 to a horizontal polarization (i.e., parallel to the direction of travel of the metal strip 16 along the length of the strip) or to a vertical polarization (i.e., perpendicular to the direction of travel of the metal strip 16 along the length of the strip).

A reflection detector 42 is positioned along the sheet metal strip 16 to detect the laser light reflecting 36 from the moving surface of the metal strip. In the example shown in FIG. 2, the reflection detector 42 is positioned directly opposite the diode laser source 32 across the width dimension of the metal strip 16. The reflection detector 42 in the preferred embodiment is a smart camera, although other equivalent types of devices that can detect reflected light could be used. In the example shown in FIG. 2, the diode laser 32 is positioned relative to the surface of the moving metal strip 16 so that the laser beam 34 is oriented at a 45 degree angle relative to the surface. In a like manner, the reflection detector 42 is positioned relative to the moving surface of the metal strip 16 so that the center axis of the camera 42 is oriented at a 45 degree angle relative to the surface of the strip. In alternate embodiments, the reflection detector 42 could be positioned directly above the reflecting beam 36 on the metal strip surface. In further alternate embodiments, the laser light source 32 and reflection detector 42 could be positioned in line with the length dimension of the metal strip 16.

A second linear polarization filter 44 is associated with the reflection detector 42. The second filter 44 is positioned so that the laser light beam reflection 36 detected by the reflection detector 42 is detected through the second filter 44. The second polarization filter 44 would be oriented relative to the metal strip 16 in the same polarization orientation as the first polarization filter 38. That is, if the polarization of the first filter 38 is horizontal, then the second filter 44 is also positioned for horizontal polarization. If the first filter 38 is positioned for vertical polarization of the laser light beam, then the second filter 44 is positioned for vertical orientation of the reflected laser light beam 36. This enables the depolarization of the reflected laser light beam 36 to be determined by the reflection detector 42. Thus, by the reflection detector 42 detecting the absolute reflectivity of the reflected beam 36 from the moving surface of the sheet metal strip 16, and by the reflection detector 42 detecting the depolarization of the reflected laser beam 36, an indication of the surface roughness or residual scale on the surface of the metal strip 16 can be arrived at.

The light reflectivity and the depolarizing properties of the base steel surface of the metal strip and of the various oxides that may form on the surface are specific to the chemistry of the surface. However, for an absolute measurement system to use either the reflectivity or depolarizing properties of the metal surface to measure the percentage of steel and the percentage of oxide on the metal surface the surface would have to be perfectly flat, or more correctly perfectly flat and perfectly smooth. In reality this is not the case. The surface of the metal strip 16 will have a certain degree of texture or roughness. The texture or roughness of the surface being inspected by the apparatus of the invention will influence the intensity of the light that is collected by the detectors of the system. The surface roughness determines how much of the light is reflected and aimed at the detector. For example, if the surface of the strip 16 were perfectly flat and perfectly smooth, all of the reflected light would be directed toward the detectors of the system. Because the surface of the strip 16 is not perfectly flat and is not perfectly smooth, only a portion of the reflected light will be directed toward the detectors, with the remaining reflected light being scattered in directions away from the detectors. Thus, the surface roughness detector 20 described earlier provides an indication of how much light reflected off the surface of the strip 16 would be aimed or directed at the detectors. The surface chemistry of the strip 16, i.e., the percentage of steel and the percentage of oxide on the surface, determines the intensity of the light reflected and/or the depolarization of the light reflected toward the detectors. Because all scale that can form on a metal surface may not be the same oxide or chemistry, the three sensors of the invention are used in combination to cover all options or residual oxide possibilities. In some situations only two of the sensors would be needed to adequately determine residual oxide on the surface of the strip 16, and in some situations only one of the sensors would be needed. The three sensors employed in the apparatus of the invention enable the apparatus to be used to detect residual oxide on the surface of the metal strip in all conceivable processing systems.

A computerized monitoring and control system 48 communicates with the reflection detector 42 and the roughness detector 20. The system 48 receives signals from the reflection detector 42 that are indicative of the laser beam reflection 36 from the surface of the sheet metal strip 16. The system 48 is provided with custom software that acquires images from the reflection detector 42 and processes data from the signals received from the reflection detector 42 to provide an indication to a user monitoring a display portion of the system 48 of the surface roughness or the residual scale on the moving surface of the metal strip 16 moving past the laser light source 32 and the reflection detector 42. Thus, real time detection of residual oxide scale on the surface of the sheet metal strip 16 moving through the apparatus of FIG. 1 is provided by the apparatus of FIG. 2. In this manner, the apparatus of FIG. 2 provides a cost efficient and time efficient apparatus and method of detecting residual oxide scale on the surfaces of the sheet metal strip 16, and enables real time adjustments to the processing line to achieve a desired level of residual scale.

FIG. 3 shows a schematic representation of an alternate embodiment of the invention. FIG. 3 represents a multiple single spot detection system in which multiple laser beam spots are projected onto the moving surface of the metal strip 16, across the width dimension of the middle strip as shown in FIG. 3.

In the embodiment of FIG. 3, multiple sensor units 52 are positioned “side-by-side” across the width dimension of the metal strip 16. Each sensor unit 52 of the plurality of sensor units is comprised of a laser light source such as the laser light source 32 of the previously described embodiment, and a reflection detector such as the reflection detector 42 of the previously described embodiment. The plurality of laser light sources direct a beam of laser light 54 to the moving surface of the metal strip 16. The reflections of the beams of laser light 56 are detected by the reflection detectors of the sensor units 52. Polarizing filters are provided in each of the sensor units 52 to polarize the laser beams 54 directed toward the moving surface of the metal strip 16, and to determine the depolarization of the beam reflections 56 sensed by the reflection detectors of each of the sensor units 52. As in the previously described embodiment, the plurality of sensor units 52 and the roughness detector 20 communicate with a monitoring and control system 48 that provides an indication of the residual scale on the moving surface of the metal strip 16 from signals received from the reflection detectors of the plurality of sensor units 52. In this manner, the plurality of sensor units 52 effectively monitor the residual oxide scale on the surface of the metal strip 16 moving past the apparatus.

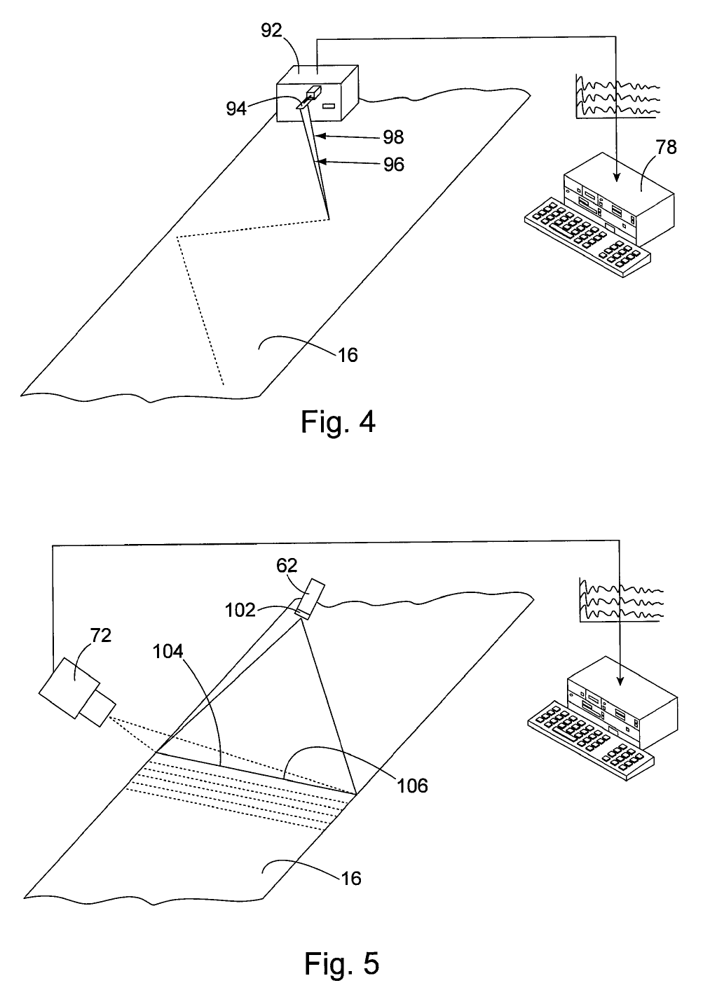

FIG. 4 is a schematic representation of a further embodiment of the apparatus of the invention. The apparatus of FIG. 4 is a single scanning spot embodiment. The apparatus employs a laser light source and a reflection detector, a roughness detector and the monitoring and control system just as in the first described embodiment of the invention. The laser light source and the reflection detector are contained in a sensor unit 62 positioned above the center of the width dimension of the moving sheet metal strip 16. Just as in the previously-described embodiment, the sensor unit 62 also includes first and second linear polarizing filters. In addition, the sensor unit 62 includes movable scanning optics 64 that are positioned relative to the laser light source to receive the beam of laser light from the laser light source and direct the beam of laser light 66 across the width dimension of the sheet metal strip 16. As represented in FIG. 4, the scanning optics 64 direct the beam of laser light 66 in a programmed path over the surface of the metal strip 16, thereby effectively monitoring the residual oxide scale across the surface of the metal strip moving past the sensor unit 62. One example of the scanning optics 64 of the sensor unit 62 is an oscillating mirror that is positioned to direct the laser light beam 66 in the predetermined programmed pattern across the width of the moving surface of the metal strip 16. As in the previously-described embodiments, the reflection detector contained in the sensor unit 62 detects the beam reflection 68. The reflection detector in the embodiment of FIG. 4 is positioned side-by-side with the laser light source in the sensor unit 62, and detects the reflection 68 of the laser beam through the scanning optics 64.

FIG. 5 shows a schematic representation of a still further embodiment of the apparatus of the invention. The embodiment of FIG. 5 is a line scan imaging embodiment. As in the first-described embodiment, the embodiment of FIG. 5 employs a roughness detector 20 and a monitoring and control system 48, and a laser light source 32 and a reflection detector 42 positioned above the width dimension of the moving surface of the metal strip 16. In FIG. 5, the laser light source 32 and the reflection detector 42 are positioned in line along the length dimension of the moving metal strip 16. As in the previously-described embodiments, first and second polarizing filters are associated with the respective laser light source 32 and the reflection detector 42. In addition, line generating optics 72, for example, a line generating laser diode or fiber optic line light guides, are associated with the laser light source 32. The line generating optics 72 are positioned relative to the laser light source 32 to receive the beam of laser light from the laser light source and direct a line of laser light 74 across the width dimension of the moving surface of the sheet metal strip 16. The line of laser light 74 is projected on the metal strip 16 in an orientation that is perpendicular to the length dimension and the direction of movement of the metal strip. The line of laser light 74 is scattered or reflected 76 on the moving surface of the metal strip 16. The reflected light 76 is sensed by the reflection detector 42. The reflection detector 42 can be a smart camera as in the previously-described embodiments, could also be a line-scan camera fitted with a cross-polarizing filter, or other equivalent equipment. As in the previously-described embodiments, the reflection detector 42 communicates with the computerized monitoring and control system 48 and provides signals to the system 48 that are indicative of the scattered or reflected line of laser light 76 on the moving surface of the metal strip 16. In this manner, the line of laser light projected across the width of the metal strip 16 in the FIG. 5 embodiment effectively monitors the residual scale on the surface of the metal strip moving past the apparatus.

In addition to locating the apparatus of the invention 18 at the output of a metal surface processing system 22 such as a pickling tank or a mechanical scale removal system such as that depicted in FIG. 1, an additional apparatus 18′ with an additional roughness detector 20′ can be located within the processing system 22. With this arrangement schematically represented in FIG. 1, the progress of scale removed from the metal surfaces 16 by the system 22 can be determined and a prediction made of the final condition if the operating conditions remain fixed. The apparatus 18′ at the early stage of the system 22 provides an indication of the scale present on the metal surfaces 16 at a predetermined stage of the process allowing the process to be controlled in a feed forward manner in addition to the feed back options enabled by the apparatus 18 at the output of the system 22. With there being two scale removal systems 22, for example two pickling systems or two mechanical systems for removing scale, the first sensor 18′ is an “in-process” sensor. The “in-process” sensor 18′ provides an indication of the scale removal from the surfaces of the metal strip 16 at an intermediate point of the overall scale removal process. For example, at the location along the system 22 of the “in-process” sensor 18′ it may be desirable to detect 60 percent of the strip surface 16 as steel and 40 percent of the surface as oxide. If the “in-process” sensor 18′ detects 55 percent of the surface as steel and 45 percent of the surface as oxide, the computerized control system of the apparatus could immediately slow the movement of the strip 16 through the descaling apparatus sections 22 to the point where the surfaces of the strip 16 would receive enough extra exposure in the downstream scale removal apparatus 22 positioned to the left in FIG. 1 to substantially clean all of the scale from the strip surfaces leaving the downstream apparatus 22.

The sensor 18 after the downstream cell 22 or the left-hand cell 22 gives feedback signals that can be used to slow down the speed of the strip 16 moving through the apparatus 22 if the strip 16 leaving the downstream apparatus 22 is not scale free.

In a like manner, if the “in-process” sensor 18′ is set to detect 60 percent of the strip surface 16 as steel and 40 percent as oxide at that stage of the processing, and the “in-process” sensor 18′ detects 70 percent of the surface as steel and 30 percent of the surface as oxide, the computerized control system could increase the speed of the metal strip 16 moving through the apparatus 22 to improve the efficiency of processing the metal strip 16, provided the sensor 18 at the output end of the downstream apparatus 22 continues to detect that the surfaces of the strip 18 exiting the downstream apparatus 22 are scale free. This enables an improvement in the quality of the metal surfaces 16 over the prior visual inspection method, and also allows the run time of the system 22 to run very close to an optimum speed. Each of the apparatus discussed provides real time detection of residual oxide scale on the surface of the sheet metal strip 16 moving through the line. This provides a cost efficient and time efficient apparatus and method of detecting residual oxide scale on the surfaces of the sheet metal strip 16, and enables real time adjustments to the descaling device 22 of the line to achieve a desired level of residual scale.

1. An apparatus that detects scale on a metal surface where the metal surface has an area with mutually perpendicular length and width dimensions and the metal surface and the apparatus are moving relative to each other causing the metal surface to move past the apparatus, the apparatus comprising:
a light source that projects light onto the metal surface with the light reflecting from the metal surface;
a reflection detector that detects the light reflecting from the metal surface; and,
a control system communicating with the reflection detector, the system being operable to produce signals indicative of scale on the metal surface from the light reflecting from the metal surface detected by the reflection detector.

2. The apparatus of claim 1, further comprising:
a surface roughness detector communicating with the control system.

3. The apparatus of claim 1, further comprising:
the light source and the reflection detector being positioned side-by-side within the width dimension of the metal surface.

4. The apparatus of claim 1, further comprising:
the light source being one of a plurality of light sources that each project light onto the metal surface with the light reflecting from the metal surface;
the reflection detector being one of a plurality of reflection detectors that each detect light from one of the plurality of light sources reflecting from the metal surface; and,
the control system communicating with each of the reflection detectors.

5. The apparatus of claim 4, further comprising:
the plurality of light sources being arranged across the metal surface; and,
the plurality of reflection detectors being arranged across the metal surface.

6. The apparatus of claim 1, further comprising:
the light source projecting polarized light.

7. The apparatus of claim 1, further comprising:
movable scanning optics positioned to receive the light projected from the light source and direct the light across the metal surface in response to movement of the scanning optics.

8. (canceled)

9. An apparatus that detects scale on a metal surface where the metal surface has an area with mutually perpendicular length and width dimensions and the metal surface and the apparatus are moving relative to each other causing the metal surface to be moved past the apparatus, the apparatus comprising:
a laser light source positioned to project a beam of laser light onto the metal surface with the laser light reflecting from the metal surface;
a first polarizing filter positioned to receive the beam of laser light projected from the laser light source and polarize the beam of laser light;
a second polarizing filter positioned to receive the laser light reflecting from the metal surface and polarize the laser light reflecting from the metal surface;
a reflection detector positioned to detect the laser light reflecting from the metal surface that has been polarized by the second polarizing filter; and,
a control system communicating with the reflection detector and being operable to produce signals indicative of scale on the metal surface detected by the reflection detector.

10. The apparatus of claim 9, further comprising:
a roughness detector positioned to sense roughness of the metal surface, the control system communicating with the roughness detector.

11. The apparatus of claim 9, further comprising:
the reflection detector detects absolute reflectivity and depolarization from the laser light reflecting from the metal surface that has been polarized by the second polarizing filter.

12. The apparatus of claim 9, further comprising:
the first polarizing filter polarizes the beam of laser light as a linear polarized beam that is oriented parallel to the metal surface.

13. The apparatus of claim 9, further comprising:
the first polarizing filter polarizes the beam of laser light as a linear polarized beam that is oriented perpendicular to the metal surface.

14. An apparatus that detects scale on a metal surface where the metal surface has an area with mutually perpendicular length and width dimensions and the metal surface and the apparatus are moving relative to each other causing the metal surface to move past the apparatus, the apparatus comprising:
a plurality of laser light sources that are positioned relative to the metal surface to project beams of laser light across the width of the metal surface where each of the beams of laser light reflects from the metal surface;
a plurality of reflection detectors that are positioned relative to the metal surface to detect light reflecting from the metal surface from each beam of laser light projected from the plurality of laser light sources; and,
a control system communicating with the plurality of reflection detectors and being operable to produce signals indicative of scale on metal surface detected by the plurality of reflection detectors.

15. The apparatus of claim 14, further comprising:
a roughness detector positioned to sense roughness of the metal surface, the control system communicating with the roughness detector.

16. The apparatus of claim 14, further comprising:
a plurality of sensor units arranged side-by-side across the width of the metal surface with each sensor unit including a single laser light source of the plurality of laser light sources and a single reflection detector of the plurality of reflection detectors.

17. (canceled)

18. The apparatus of claim 14, further comprising:
the plurality of laser light sources each including a first polarizing filter that polarizes light from the laser light source; and,
the plurality of reflection detectors each including a second polarizing filter that receives laser light reflecting from the metal surface.

19. (canceled)

20. (canceled)

21. An apparatus that detects scale on a metal surface where the metal surface has an area with mutually perpendicular length and width dimensions and the metal surface and the apparatus are moved relative to each other causing the metal surface to move past the apparatus, the apparatus comprising:
a laser light source that projects a beam of laser light;
movable scanning optics positioned relative to the laser light source and the metal surface to receive the beam of laser light from the laser light source and direct the beam of laser light across the width dimension of the metal surface with the beam of laser light reflecting from the metal surface in response to movement of the scanning optics;
a reflection detector that detects the reflecting of the beam of laser light from the metal surface; and,
a control system communicating with the reflection detector and being operable to produce signals indicative of scale on the metal surface detected by the reflection detector.

22. The apparatus of claim 21, further comprising:
a roughness detector positioned to sense roughness of the metal surface, the control system communicating with the roughness detector.

23. (canceled)

24. The apparatus of claim 21, further comprising:
the laser light source includes a first polarizing filter that polarizes laser light projected from the laser light source; and,
the reflection detector includes a second polarizing filter that receives the reflecting of the beam of laser light from the metal surface.

25. (canceled)

26. (canceled)

27. The apparatus of claim 21, further comprising:
the scanning optics including a moving mirror that receives the beam of laser light from the laser light source and directs the beam of laser light in a scanning pattern on the metal surface.

28. An apparatus that detects scale on a metal surface where the metal surface has an area with mutually perpendicular length and width dimensions and the metal surface and the apparatus are moving relative to each other causing the metal surface to move past the apparatus, the apparatus comprising:
a laser light source that projects a beam of laser light;
line generating optics positioned relative to the laser light source and the metal surface to receive the beam of laser light from the laser light source and direct a line of laser light across the width dimension of the metal surface with the line of laser light reflecting from the metal surface;
a reflection detector that detects the reflecting line of laser light from the metal surface; and,
a control system communicating with the reflection detector and being operable to produce signals indicative of scale on the metal surface detected by the reflection detector.

29. The apparatus of claim 28, further comprising:
a roughness detector positioned to sense roughness of the metal surface, the control system communicating with the roughness detector.

30. (canceled)

31. The apparatus of claim 28, further comprising:
the laser light source includes a first polarizing filter that polarizes laser light projected from the laser light source; and,
the reflection detector includes a second polarizing filter that receives the reflecting of the beam of laser light from the metal surface.

32. The apparatus of claim 28, further comprising:
the laser light source includes a polarizing filter that polarizes the beam of laser light from the laser light source as a linear polarized beam that is oriented perpendicular to the length dimension of the metal surface.

33. The apparatus of claim 28, further comprising:
the reflection detector including a line scan camera.

34. A method of detecting scale on a metal surface where the metal surface has an area with mutually perpendicular length and width dimensions, the method comprising:
providing a light source that projects light onto the metal surface with the light reflecting from the metal surface;
providing a reflection detector and detecting the light reflecting from the metal surface with the reflection detector;
providing relative movement between the metal surface and the light source and the reflection detector where the light source and the reflective detector are moving relative to the metal surface along the length dimension of the metal surface; and,
providing a control system and communicating the control system with the reflection detector, and operating the control system to produce signals that are indicative of scale on the metal surface from the light reflecting from the metal surface detected by the reflection detector.

35. The method of claim 34, further comprising:
sensing a surface roughness of the metal surface and communicating the surface roughness to the control system.

36. The method of claim 34, further comprising:
polarizing the light projected from the light source.

37. The method of claim 36, further comprising:
polarizing the light reflecting from the metal surface.

38. The method of claim 34, further comprising:
detecting the absolute reflectivity and the depolarization of the light reflecting from the metal surface.

39. The method of claim 34, further comprising:
polarizing the light projected from the light source as a linear polarized beam that is oriented parallel to the length dimension of the metal surface.

40. The method of claim 34, further comprising:
polarizing the light projected from the light source as a linear polarized beam that is oriented perpendicular to the length dimension of the metal surface.

41. The method of claim 34, further comprising:
providing movable scanning optics and receiving the light projected from the light source with the scanning optics and directing the light from the scanning optics across the width dimension of the metal surface.

42. The method of claim 34, further comprising:
providing line generating optics and receiving the light projected from the light source with the line generating optics and directing a line of light from the line generating optics across the width dimension of the metal surface.
